(19) United States
(12) Patent Application Publication
(10) Pub. No.: US 2025/0238787 A1
(43) Pub. Date: Jul. 24, 2025

(54) SYSTEMS AND METHODS FOR DIGITAL IDENTITY AND ACCOUNT ABSTRACTION

(71) Applicant: JPMORGAN CHASE BANK, N.A., New York, NY (US)

(72) Inventors: George KASSIS, London (GB); Kirsten JONES, Southbourne (GB); Aditya Mayur TADAY, Hoboken, NJ (US); Alexander PRAGER-MILLER, Brooklyn, NY (US)

(21) Appl. No.: 19/034,256

(22) Filed: Jan. 22, 2025

Related U.S. Application Data
(60) Provisional application No. 63/623,572, filed on Jan. 22, 2024.

(51) Int. Cl. G06Q 20/36; G06Q 20/38; G06Q 20/40

(52) U.S. Cl. CPC G06Q 20/36; G06Q 20/3821; G06Q 20/3825; G06Q 20/401; G06Q 2220/00

(57) ABSTRACT

Systems and methods for digital identity and account abstraction are disclosed. A method may include: creating, by an application executed by a user electronic device in an off-chain environment, a user operation for a transaction based on an intention received from a user; receiving, by an entry point contract in an on-chain environment, the user operation with a verifiable credential for the user; validating, by the entry point contract, the user operation using a validation function in a smart contract wallet; determining, by the entry point contract, that there is a paymaster to sponsor the transaction; determining, by a paymaster contract for the paymaster, that the transaction should be sponsored based on the verifiable credential for the user; executing, by the entry point contract, the transaction using an arbitrary execution function in the smart contract wallet; and invoking, by the entry point contract, a post-operation that performs post-operation logic.

### RELATED APPLICATIONS

This application claims priority to, and the benefit of, U.S. Provisional Patent Application Ser. No. 63/623,572, filed Jan. 22, 2024, the disclosure of which is hereby incorporated, by reference, in its entirety.

### BACKGROUND OF THE INVENTION

### 1. Field of the Invention

Embodiments relate to systems and methods for digital identity and account abstraction.

### 2. Description of the Related Art

Web3 provides a user's or entity's representation on a blockchain with an account that can send and receive cryptocurrency, as well as interact with other on-chain accounts. These accounts may be externally owned accounts or smart contract accounts. Transfers may generally originate from externally owned accounts.

A smart contract account is a programmable account that can store assets in on-chain smart contracts. Rather than being controlled by a private key, smart contract accounts are controlled by arbitrary, customizable verification logic. This provides smart contract accounts with security benefits, as not being controlled by a single private key means that access is not dependent on a single person remembering that private key, and with functionality expansion, as rules for things like transfer limits and social recovery may be established.

### SUMMARY OF THE INVENTION

Systems and methods for digital identity and account abstraction are disclosed. In one embodiment, a method may include: (1) creating, by an application executed by a user electronic device in an off-chain environment, a user operation for a transaction based on an intention received from a user; (2) receiving, by an entry point contract in an on-chain environment, the user operation with a verifiable credential for the user; (3) validating, by the entry point contract, the user operation using a validation function in a smart contract wallet; (4) determining, by the entry point contract, that there is a paymaster to sponsor the transaction; (5) determining, by a paymaster contract for the paymaster, that the transaction should be sponsored based on the verifiable credential for the user; (6) executing, by the entry point contract, the transaction using an arbitrary execution function in the smart contract wallet; and (7) invoking, by the entry point contract, a post-operation that performs post-operation logic.

In one embodiment, the method may also include: signing, by a signer service in the off-chain environment, the user operation.

In one embodiment, the method may also include: creating, by the signer service, an on-chain verifiable presentation for the verifiable credential, wherein the verifiable credential may be received from an identity digital wallet for the user in the off-chain environment.

In one embodiment, the user operation may include a blockchain address for the user, a unique identifier, initialization code for setting up a new contact for the transaction, and a gas limit for execution and verification of the transaction.

In one embodiment, the method may also include: bundling, by a bundler in the off-chain environment, the user operation with a plurality of user operations.

In one embodiment, the entry point contract further validates the user operation using an authorization module smart contract.

In one embodiment, the paymaster sponsors a gas fee for the transaction.

According to another embodiment, a method may include: (1) creating, by an application executed by a user electronic device in an off-chain environment, a user operation for a transaction based on an intention received from a user; (2) receiving, by a paymaster service in the off-chain environment, the user operation; (3) determining, by the paymaster service, that the transaction is eligible for sponsoring; (4) receiving, by the paymaster service, a verifiable presentation comprising a verifiable credential for the user from a user identity wallet, wherein the verifiable presentation is signed by a signer service; (5) passing, by the paymaster service, the user operation and the verifiable presentation to a merchant paymaster service; (6) verifying, by the merchant paymaster service and using an off-chain verification service, the user operation; (7) receiving, by an entry point contract in an on-chain environment, the user operation with the verifiable credential for the user; (8) validating, by the entry point contract, the user operation using a validation function in a smart contract wallet; (9) determining, by the entry point contract, that there is a paymaster to sponsor the transaction; (10) determining, by a paymaster contract for the paymaster, that the transaction should be sponsored based on the verifiable credential for the user; (11) executing, by the entry point contract, the transaction using an arbitrary execution function in the smart contract wallet; and (12) invoking, by the entry point contract, a post-operation that performs post-operation logic.

In one embodiment, the method may also include: signing, by a signer service in the off-chain environment, the user operation.

In one embodiment, the method may also include: creating, by the signer service, an on-chain verifiable presentation for the verifiable credential, wherein the verifiable credential may be received from an identity digital wallet for the user in the off-chain environment.

In one embodiment, the user operation may include a blockchain address for the user, a unique identifier, initialization code for setting up a new contact for the transaction, and a gas limit for execution and verification of the transaction.

In one embodiment, the method may also include: bundling, by a bundler in the off-chain environment, the user operation with a plurality of user operations.

In one embodiment, the entry point contract further validates the user operation using an authorization module smart contract.

In one embodiment, the paymaster sponsors a gas fee for the transaction.

According to another embodiment, a non-transitory computer readable storage medium may include instructions stored thereon, which when read and executed by one or more computer processors, cause the one or more computer processors to perform steps comprising: creating, using an application executed by a user electronic device in an off-chain environment, a user operation for a transaction based on an intention received from a user; receiving, using a paymaster service in the off-chain environment, the user operation; determining, using the paymaster service, that the transaction is eligible for sponsoring; receiving, using the paymaster service, a verifiable presentation comprising a verifiable credential for the user from a user identity wallet, wherein the verifiable presentation is signed by a signer service; passing, using the paymaster service, the user operation and the verifiable presentation to a merchant paymaster service; verifying, using the merchant paymaster service and using an off-chain verification service, the user operation; receiving, using an entry point contract in an on-chain environment, the user operation with the verifiable credential for the user; validating, using the entry point contract, the user operation using a validation function in a smart contract wallet; determining, using the entry point contract, that there is a paymaster to sponsor the transaction; determining, using a paymaster contract for the paymaster, that the transaction should be sponsored based on the verifiable credential for the user; executing, using the entry point contract, the transaction using an arbitrary execution function in the smart contract wallet; and invoking, using the entry point contract, a post-operation that performs post-operation logic.

In one embodiment, the non-transitory computer readable storage medium may also include instructions stored thereon, which when read and executed by the one or more computer processors, cause the one or more computer processors to perform steps comprising: signing the user operation.

In one embodiment, the non-transitory computer readable storage medium may also include instructions stored thereon, which when read and executed by the one or more computer processors, cause the one or more computer processors to perform steps comprising: creating an on-chain verifiable presentation for the verifiable credential, wherein the verifiable credential may be received from an identity digital wallet for the user in the off-chain environment.

In one embodiment, the user operation may include a blockchain address for the user, a unique identifier, initialization code for setting up a new contact for the transaction, and a gas limit for execution and verification of the transaction.

In one embodiment, the non-transitory computer readable storage medium may also include instructions stored thereon, which when read and executed by the one or more computer processors, cause the one or more computer processors to perform steps comprising: bundling the user operation with a plurality of user operations.

In one embodiment, the non-transitory computer readable storage medium may also include instructions stored thereon, which when read and executed by the one or more computer processors, cause the one or more computer processors to perform steps comprising: validating the user operation using an authorization module smart contract.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for digital identity and account abstraction according to an embodiment;

FIG. 2 illustrates a flow diagram for digital identity and account abstraction according to an embodiment;

FIG. 3 depicts a method for using an off-chain verifiable credential with a paymaster to determine eligibility for gas sponsorship according to an embodiment;

FIG. 4 depicts an exemplary computing system for implementing aspects of the present disclosure.

### DETAILED DESCRIPTION OF PREFERRED EMBODIMENTS

Systems and methods for digital identity and account abstraction are disclosed. In embodiments, decentralized identities and verifiable credentials may be used to govern an on-chain smart contract wallet, may be used on-chain to check for paymaster eligibility, may be used to access gated on-chain content/function, etc.

Rather than using externally owned accounts as primary accounts, embodiments may use account abstraction to use smart contract accounts instead. Thus, each user desiring the security and functionality benefits of smart contract accounts may use its own smart contract account.

Embodiments may enhance transaction processes by enabling programmable payments, where custom logic and workflows may be implemented in smart contract wallets to create flexible payment structures. Governance and authorization may be strengthened through the use of verifiable credentials, which establish rules for payment execution and define user roles for smart account interactions. Furthermore, gasless transactions may be sponsored for users who present specific verifiable credentials, thereby reducing transaction costs and improving accessibility.

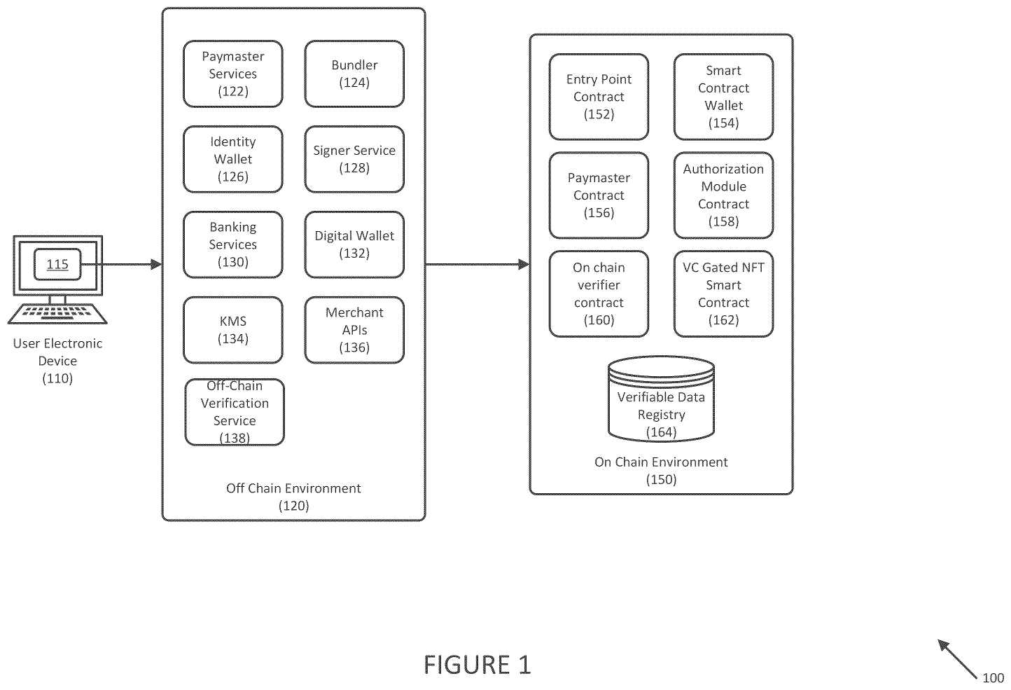

FIG. 1 depicts a system for digital identity and account abstraction according to an embodiment. System 100 may include user electronic device 110, which may be a computer (e.g., a workstation, desktop, laptop, notebook, tablet, etc.), a smart device (e.g., smart phone, smart watch, smart glasses, etc.), and Internet of Things (“IoT”) device, etc. User electronic device 110 may execute application 115, which may be a software application. Application 115 may be a distributed application (or “dApp”) that may enable the user to connect and use the user's smart contract wallet 134 along with the user's off-chain decentralized identities and verifiable credentials. Application 115 may connect to different paymaster services 122 in off-chain environment 120 to determine paymaster eligibility.

In addition, application 115 may connect to different paymaster services 122 in off-chain environment 120 to determine paymaster eligibility by leveraging algorithms that assess user credentials and transaction history, ensuring that only eligible transactions are sponsored. This may also integrate with various financial service providers (not shown) to offer tailored financial products and services based on verified user data, to determine paymaster eligibility, etc.

In embodiments, application 115 may allow the user to access and use the user's smart contract wallet 134 in conjunction with a decentralized identity from identity wallet 126, paymaster services 122, signer service 128, banking services 130, digital wallets 132, key management services (KMS) 134, merchant APIs 136, off-chain verification service 138, etc. provided in off chain environment 120. Application 115 may rely on services such as a paymaster services 122, bundler 124, identity wallet 126, signer service 128, etc. to create user operations that ultimately communicate with the user's smart contract wallet 134.

Paymaster services 122 may include a backend service that is linked to application 115, serving as a subcomponent responsible for checking, facilitating, and providing gas sponsorship data for a user operation, such as a desired task to be performed. As used herein, a user operation may refer to a structured set of actions initiated by a user using application 115 that may interact with off-chain environment 120. A user operation may encompass the user's intent and the necessary data required to execute a transaction or series of transactions on the blockchain. A user operation may include the following components: a sender address (e.g., the blockchain address of the user initiating the operation); a nonce (e.g., a unique number to ensure the operation is processed in the correct order and to prevent replay attacks); call data (e.g., the specific instructions or actions the user intends to perform, such as transferring assets or invoking a smart contract function; gas limits and fees (e.g., parameters defining the computational resources allocated for the operation and the associated transaction fees); paymaster and data (e.g., information related to transaction sponsorship, including any third-party entities covering the transaction fees); signature (e.g., a cryptographic signature verifying the authenticity and integrity of the operation, typically generated by a signer service); etc. User operations are fundamental to enabling complex interactions within blockchain ecosystems, allowing users to perform actions securely and efficiently while leveraging decentralized identity and account abstraction mechanisms.

Paymaster services 122 may find the correct eligibility for sponsoring transaction fees (e.g., gas fees) either by itself (the owner of application 115) or by connecting to any given merchant based on the user's intent and their verifiable credentials. Paymaster services 122 may integrate with application 115 to ensure seamless communication and data exchange, enabling it to assess user credentials and transaction history effectively. Paymaster services 122 may also leverage a user's verifiable credentials for user verification purposes. Paymaster services 122 may operate by evaluating predefined criteria and algorithms to determine sponsorship eligibility, ensuring that only qualified transactions receive sponsorship.

Identity wallet 126 may include a backend service that stores a user's verifiable credential data. Identity wallet 126 may allow a user to claim the user's verifiable credentials, which can include identity attributes, certifications, or other attestations, from a variety of issuers, such as institutions, merchants, identity providers, and other trusted entities, and work with signer service 128 and/or other microservices to produce on-chain representations of verifiable presentations. These on-chain representations may include zero-knowledge (“ZK”) proofs and other proof systems, which are the proofs of verifiable credentials signed by the user.

Signer service 128 may include a backend service that plays a role in the authentication and authorization processes by producing signatures. It is responsible for signing verifiable credentials, user operations, and transactions, ensuring the integrity and authenticity of data exchanged within the system.

A typical flow involves application 115 interacting with identity wallet 126, which then uses signer service 128 to perform signing operations. For example, signer service 128 may use EIP-712 (Ethereum typed structured data hashing and signing) to present readable and securely signed messages. Signer service 128 may sign regular Ethereum transactions, may sign Ethereum typed data, and may digitally and cryptographically sign messages. It supports various types of cryptographic functionality related to signing, including different types of cryptographic curves (e.g., passkeys).

Bundler 124 may be an entity within blockchain systems that may be responsible for aggregating multiple user operations into a single transaction or batch for submission to the blockchain. For example, bundler 124 may collect individual user operations from various sources and organizes them into a batch that can be processed together, may analyze the batch to optimize resource usage, such as minimizing gas fees and maximizing transaction throughput; may conduct preliminary checks to ensure that each user operation within the batch meets the necessary criteria for execution, such as valid signatures and sufficient funds; may submit the aggregated batch to the blockchain network for execution, serving as an intermediary between users and the blockchain; etc. Bundler 124 may take various forms, including a microservice, an API, an individual, or an institution, depending on the specific requirements and design of the system.

For example, after the application creates a completed signed user operation, it may pass the user operation to bundler 124. Bundler 124 acts as an intermediary that collects and organizes these operations before submitting them to on-chain environment 150. blockchain. This role can be played by various entities, such as decentralized networks, third-party service providers, or even the application itself, depending on the implementation and network architecture.

Banking service 130 may provide any suitable banking services to the user.

Digital wallets 132 may store, for example, payment credentials for the user.

Key management services (KMS) 134 may provide any suitable key management services for off-chain environment 120.

Merchant APIs 136 may provide access to merchant paymaster services (not shown).

Off-chain verification service 138 may validate, for example, verifiable presentations. For example, off-chain verification service 138 may check digital signatures to ensure that it was issued by a trusted authority, may validate digital signatures against the verifiable data registry to confirm that they are current and not revoked, and verifies the chain of trusts to ensure the digital signatures was issued through a legitimate and trusted path.

On-chain environment 150 may include entry point contract 152, smart contract wallet 154, paymaster contract 156, authorization module contract 158, on chain verifier contract 160, verifiable credential (“VC”) gated Non-Functional Token (“NFT”) smart contract 162, and verifiable data registry 164.

Entry point contract 152 may receive bundled user operations from bundler 124. Entry point contract 152 may include several key functions that collectively ensure the secure and efficient processing of user operations. For example, entry point contract 152 may perform prepayment validation, account and paymaster data verification, operation execution, and post-execution compensation.

Prepayment validation may ensure that sufficient funds or resources are available to cover the anticipated costs of executing the user operations. It may check prepayment conditions to prevent operations from proceeding without adequate financial backing.

Account and paymaster data verification may verify the authenticity and validity of the user account and any associated paymaster data. It may involve checking credentials and data integrity to ensure compliance with predefined rules and conditions, safeguarding against unauthorized or fraudulent operations.

Operation execution may be responsible for executing the validated user operations on the blockchain. It may process each operation by performing the specified actions, such as transferring assets or invoking smart contract functions, and updates the blockchain's state to reflect the results.

Post-execution compensation may manage the post-execution phase by handling compensation-related tasks. It may include settling transaction fees, updating records to reflect the completion of operations, and ensuring that any necessary reimbursements or adjustments are made.

These functions work together to maintain the integrity and reliability of the blockchain system by ensuring that user operations are processed accurately and efficiently.

Smart contract wallet 154 may include a validation and pay function, and an execute function. The validation and pay function may be responsible for verifying the authenticity and validity of a user operation before execution. This may include signature verification to ensure the operation is authorized, credential checks to validate any associated verifiable credentials, and fee management to determine and facilitate the payment of transaction fees, either by deducting from the user's balance or coordinating with a paymaster for sponsorship.

The execute function may carry out the user operation on the blockchain once validated. It may perform the specified actions, such as transferring assets or invoking smart contract functions, updating the blockchain's state to reflect the results, and managing any post-execution tasks, such as logging the transaction or notifying relevant parties.

Smart contract wallet 154 may comply with various standards under the Account Abstraction umbrella, such as ERC4337, EIP-3074, EIP-7706, EIP-6662, ERC-6900, and others.

Paymaster contract 156 may include a validation function and a post-operation function. The validation function may assess the eligibility of a user operation for sponsorship. It may verify the credentials and intent of the user operation to ensure that they meet predefined criteria for fee sponsorship. This may involve checking the user's verifiable credentials, transaction history, and any specific conditions set by the paymaster.

The post-operation function may handle tasks after the user operation has been executed. This includes managing the settlement of transaction fees, updating records to reflect the sponsorship, and performing any necessary logging or notifications to ensure transparency and accountability in the sponsorship process.

Authorization module contract 158 may be an on-chain contract that works with smart contract wallet 154. It may include a validate function that points to an authorization module (not shown) that includes validation logic. Authorization module contract 158 may include a smart contract that looks at the user operation, verifies the signatures, and communicates with the on-chain verifier contract to determine the validity of user verifiable credentials shared in the user operation.

On-chain verifier contract 160 may include a smart contract that performs comprehensive verification processes to ensure the validity of a verifiable presentation and the underlying verifiable credential. This includes checking the issuer chain of trust, verifying decentralized identifiers (DIDs), and validating the credential schema and DID methods. The verification process may also incorporate advanced systems (e.g., ZK proofs and other cryptographic methods) to enhance security and privacy.

VC gated NFT smart contract 162 may allow authorized (e.g., users with a valid VC) to mint, transfer or burn their NFTs.

Verifiable data registry 164 may include a smart contract that acts like a record house for verifiable credentials.

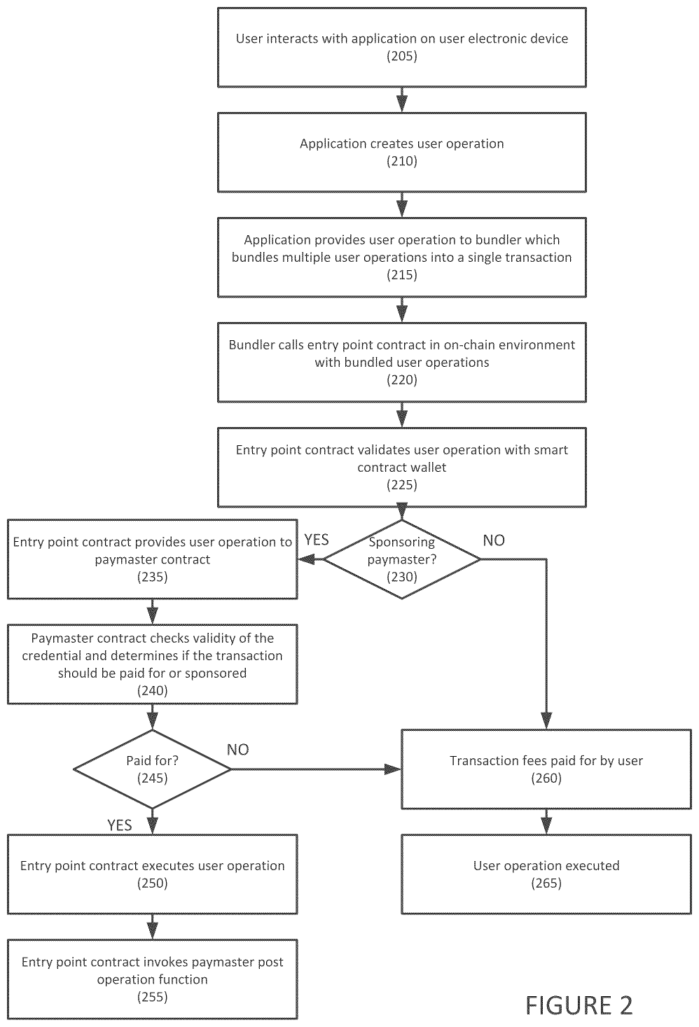

FIG. 2 depicts a flow diagram for digital identity and account abstraction is provided according to an embodiment.

In step 205, a user may interact with an application, such as a dApp, executed on a user electronic device. The application may interact seamlessly with the user's smart contract wallet that may be provided in an on-chain environment. The application may allow the user to conduct transactions with enhanced user experience benefits, such as private key abstraction, gasless transactions, and gas abstraction, which may include paying with stablecoins or deposit tokens. Transactions may also be sponsored by paymasters, reducing concerns about transaction (e.g., gas) fees.

An interface for the application may also integrate decentralized identity protocols, thereby enabling the user to prove the user's identity or other claims without revealing unnecessary personal information. This is achieved by leveraging privacy-preserving technologies such as ZK proofs or on-device processing, ensuring that sensitive data remains secure and private.

For example, a user may log in to the application via a login flow, such as OIDC/OAUTH, biometrics, social login, banking details, or single sign-on (SSO), among others. The user may then access a dashboard that shows the attributes of the user's smart contract wallet (e.g., wallet balance, NFTs, other admin functionalities, etc.). This dashboard serves as a user interface (UI) where users can interact with their digital identity and smart contract wallet.

The UI may provide a seamless and intuitive experience, with its scope and functionalities tailored to the specific application. At a broader level, the UI enables users to manage their digital identities, view and execute transactions, and access various services and features associated with their smart contract wallet, similar to an online banking portal.

The application may be linked to the user's identity wallet that may be managed by a platform for the user. The application may allow users to view, share or claim verifiable credentials.

The application may also be connected to a paymaster service, which is responsible for determining eligibility for transaction sponsorship and adding paymaster-related information to the user operation. The paymaster service acts as a subcomponent of the application, facilitating the sponsorship of transaction fees by assessing user verifiable credentials and transaction history. It may integrate seamlessly with the application to ensure efficient communication and data exchange, leveraging predefined criteria and algorithms to evaluate sponsorship eligibility.

The application may also be linked to a signer service, which is responsible for signing the user operation and creating on-chain verifiable presentations from off-chain verifiable credentials. The signer service plays a crucial role in ensuring the integrity and authenticity of data within the system. It is tasked with producing signatures for verifiable credentials, user operations, and transactions, thereby facilitating secure interactions and data exchanges. By integrating with the application, the signer service supports the authentication and authorization processes, leveraging cryptographic techniques to maintain data security.

For example, the users' identity information may be stored off-chain using a decentralized identifier compliant system. This means that the information is stored within the user's identity wallet, which supports decentralized identifiers and may also store verifiable credentials. The identity wallet acts as a secure repository for the user's identity data, ensuring privacy and control over personal information. The identity wallet may facilitate claims and credentials that are verifiable and self-sovereign. In the issuance process, the identity wallet allows users to claim verifiable credentials from trusted issuers. These verifiable credentials are then stored securely within the wallet, enabling users to present them as needed while maintaining control over their identity data.

In step 210, the application may create a user operation. In one embodiment, after the user logs in, the user may create an intention. An example of an intention may be “I want to mint a XYZ NFT because I'm a verified customer of XYZ merchant.” XYZ merchant will allow the user to mint this NFT only if the user can show a proof of verified customer verifiable credential that the merchant has issued to the end user (verification rules set by the merchant on the VC Gated NFT Smart contract).

The application may collect all the data from different services that its linked to in order to create the user operation. For example, the application may retrieve the proof of verified customer verifiable credential from the user's identity wallet and may create on-chain verifiable presentations. It may check eligibility with the paymaster service to see if there is a sponsor for this user intent. For example, paymaster services, which may be run by different entities such as merchants, the application owner, etc. may offer to sponsor transactions. The paymaster services may decide if a transaction is eligible for sponsorship based on verifiable credentials presented by the user, which prove the user's identity or meet certain criteria.

A user operation may include, for example, the sender's blockchain address, a unique number to keep operations in order, any necessary initialization code for setting up a new contract, the specific action the user wants to perform, maximum gas limits for execution and verification, the maximum fees the user is willing to pay for gas, information about potential fee sponsorship, and a digital signature to confirm the operation's authenticity.

The application may also sign the user operation with the signer service.

In step 215, the application may send the user operation to a bundler, may aggregate multiple user operations into a single transaction or block to optimize gas usage and improve processing efficiency.

In step 220, the bundler may call an entry point contract in the on-chain environment with the bundled user operations.

In step 225, the entry point contract may validate the user operation using a smart contract wallet. For example, the entry point contract may call the validation function on the smart contract wallet to perform the validation.

As a part of the validation function on the smart contract wallet, the smart contract wallet may pass the user operation to an authorization module smart contract, which may verify the user's signature and may check the rules of authorization. Because a verifiable presentation is shared with this module, it may check the validity of the verifiable credential using the on-chain verifier.

An on-chain verifier may also check the validity of the verifiable credentials by checking them against the verifiable data registry and may interact with other smart contracts on-chain. This ensures a comprehensive validation process that leverages multiple sources of verification.”

If, in step 230, there is a paymaster willing to sponsor the transaction, in step 235, the entry point contract may provide the user operation through a paymaster contract for the paymaster.

In step 240, the paymaster contract may check the validity of the verifiable credential with the on-chain verifier and may determine if the transaction should be paid for or sponsored based on the verifiable credentials provided by the user via the application as a part of the user operation.

In step 245, if the transaction should be paid for, in step 250, the entry point contract may execute the user operation by calling the arbitrary execution function on the smart contract wallet.

For example, the smart contract wallet may break the user operation into its components, such as user's intent, paymaster data, signature, and any other information required to make a transaction on the blockchain, understands the users intent (e.g., “Mint a XYZ NFT” from the callData field), and communicates (e.g., calls the mint function specifically and pass the verifiable credential data) with the end contract such as the VC gated NFT Smart Contract.

The smart contract wallet may first validate the user operation based on the verifiable credentials shared by the user via the application using the authorization module and the on-chain verifier contract. If valid, the smart contract wallet may execute the transaction logic.

The VC-Gated NFT Smart contract may then verify the validity of the verifiable credential by connecting to the on-chain verifier.

In step 255, after the smart contract is finished executing, the entry point contract may invoke the post operation function on the paymaster. This may carry out post-operation logic, including for example, logging, notifications, or other cleanup operations.

If, in step 230, there is not a sponsoring paymaster, or in step 245, the paymaster contract determines that the transaction should not be paid, in step 260, the user may pay the transaction fees from the user's smart contract wallet or any other suitable form of payment.

In step 265, the user operation may be executed. For example, the entry point contract may execute the user operation by calling the arbitrary execution function on the smart contract wallet.

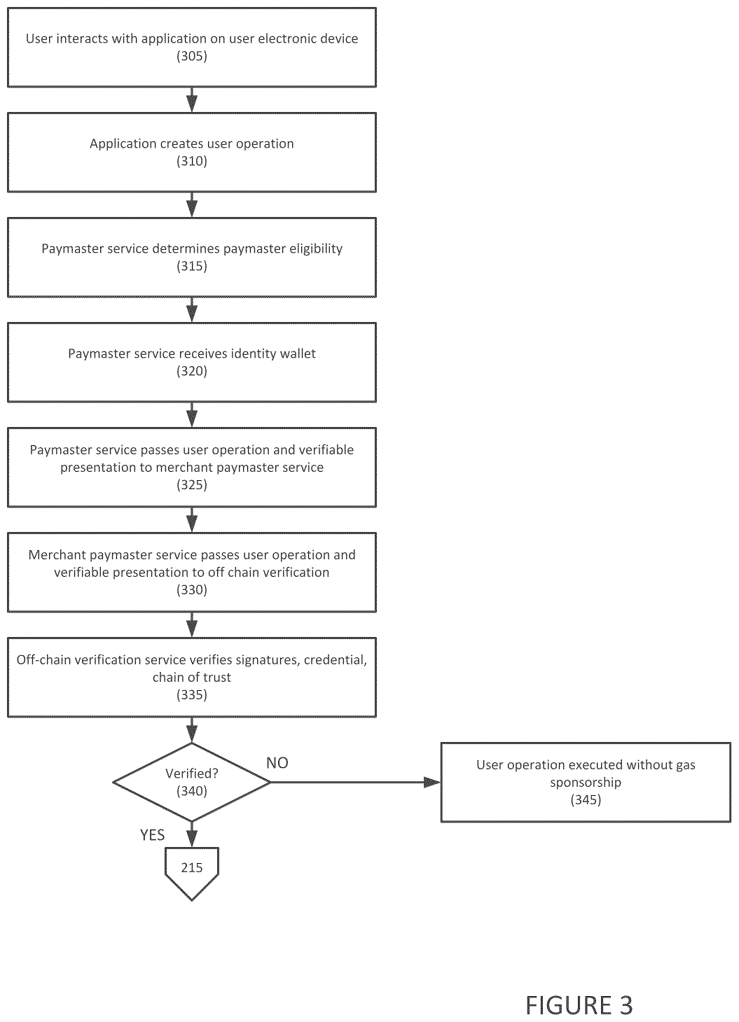

Referring to FIG. 3, a method for using an off-chain verifiable credential with a paymaster to determine eligibility for gas sponsorship is disclosed according to an embodiment.

In step 305, the user may interact with an application that may interact seamlessly with the user's smart contract wallet. The smart contract wallet may comply with ERC4337 standards.

In step 310, the application may create a user operation. In one embodiment, after the user logs in, the user may create an intention. An example of an intention may be “I want to mint a XYZ NFT because I′m a verified customer of XYZ merchant.” XYZ merchant will allow the user to mint this NFT only if the user can show a proof of verified customer verifiable credential that the merchant has issued to the end user (verification rules set by the merchant on the VC Gated NFT Smart contract).

The application may collect all the data from different services that its linked to in order to create the user operation. For example, the application may retrieve the proof of verified customer verifiable credential from the user's identity wallet and may create on-chain verifiable presentations. It may check eligibility with the paymaster service to see if there is a sponsor for this user intent. For example, paymaster services, which may be run by different entities such as merchants, the application owner, etc. may offer to sponsor transactions. The paymaster services may decide if a transaction is eligible for sponsorship based on verifiable credentials presented by the user, which prove the user's identity or meet certain criteria.

The application may also sign the user operation with the signer service.

In step 315, the paymaster service may determine paymaster eligibility, and may populate the paymaster data of the user operation. The paymaster component may understand the user's intent, may retrieve the relevant proof for the user's verifiable credentials, and may communicate with merchant owned paymaster services to populate paymaster data on the User operation before it is sent out to the bundler.

For example, assuming that the paymaster service connects with the XYZ merchant paymaster service, the XYZ merchant paymaster service may require a proof of verified customer verifiable credential in order to determine paymaster sponsorship eligibility.

In step 320, based on the user's intent, the paymaster service may request or receive the identity wallet for the proof of verified customer verifiable credential. For example, the identity wallet may create a verifiable presentation for the given verifiable credential and may request the signer service to sign the presentation. This verifiable presentation may then be shared with the paymaster service.

In step 325, the paymaster service may pass the user operation and the verifiable presentation to the merchant paymaster service (e.g., XYZ Merchant's paymaster service) using, for example, Merchant APIs.

In step 330, the merchant paymaster service may receive the user operation and the verifiable presentation and may pass it through an off-chain verification process/service.

In step 335, the off-chain verification service checks the digital signature to ensure the credential was issued by a trusted authority, validates the credential against the verifiable data registry to confirm it is current and not revoked, and verifies the chain of trust to ensure the credential was issued through a legitimate and trusted path.

If, in step 340, the verification passes, the process may continue with step 215.

If verification does not pass, in step 345, the process may continue without gas sponsorship.

The disclosures of U.S. Provisional Patent Application Ser. No. 63/126,335, filed Dec. 16, 2020, U.S. Provisional Patent Application Ser. No. 62/976,262, filed Feb. 13, 2020, U.S. patent application Ser. No. 17/174,650, filed Feb. 12, 2021, U.S. Provisional Patent Application Ser. No. 63/367,115, filed Jun. 27, 2022, and U.S. Provisional Patent Application Ser. No. 63/357,511, filed Jun. 30, 2022, U.S. Provisional Patent Application Ser. No. 63/373,814, filed Aug. 29, 2022, and U.S. patent application Ser. No. 18/342,450, filed Jun. 27, 2023 are hereby incorporated, by reference, in their entireties.

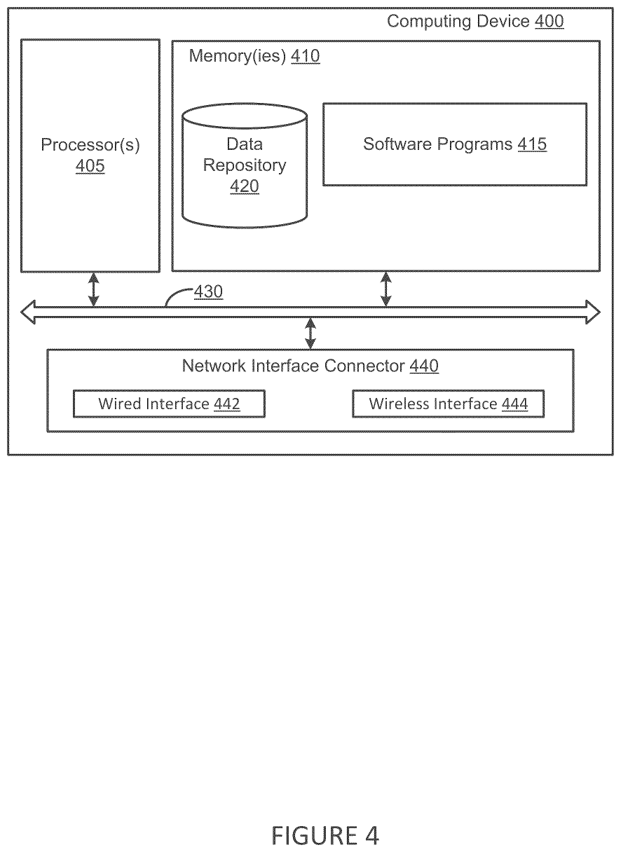

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
creating, by an application executed by a user electronic device in an off-chain environment, a user operation for a transaction based on an intention received from a user;
receiving, by an entry point contract in an on-chain environment, the user operation with a verifiable credential for the user;
validating, by the entry point contract, the user operation using a validation function in a smart contract wallet;
determining, by the entry point contract, that there is a paymaster to sponsor the transaction;
determining, by a paymaster contract for the paymaster, that the transaction should be sponsored based on the verifiable credential for the user;
executing, by the entry point contract, the transaction using an arbitrary execution function in the smart contract wallet; and
invoking, by the entry point contract, a post-operation that performs post-operation logic.

2. The method of claim 1, further comprising:
signing, by a signer service in the off-chain environment, the user operation.

3. The method of claim 2, further comprising:
creating, by the signer service, an on-chain verifiable presentation for the verifiable credential, wherein the verifiable credential is received from an identity digital wallet for the user in the off-chain environment.

4. The method of claim 1, wherein the user operation comprises a blockchain address for the user, a unique identifier, initialization code for setting up a new contact for the transaction, and a gas limit for execution and verification of the transaction.

5. The method of claim 1, further comprising:
bundling, by a bundler in the off-chain environment, the user operation with a plurality of user operations.

6. The method of claim 1, wherein the entry point contract further validates the user operation using an authorization module smart contract.

7. The method of claim 1, wherein the paymaster sponsors a gas fee for the transaction.

8. A method, comprising:
creating, by an application executed by a user electronic device in an off-chain environment, a user operation for a transaction based on an intention received from a user;
receiving, by a paymaster service in the off-chain environment, the user operation;
determining, by the paymaster service, that the transaction is eligible for sponsoring;
receiving, by the paymaster service, a verifiable presentation comprising a verifiable credential for the user from a user identity wallet, wherein the verifiable presentation is signed by a signer service;
passing, by the paymaster service, the user operation and the verifiable presentation to a merchant paymaster service;
verifying, by the merchant paymaster service and using an off-chain verification service, the user operation;
receiving, by an entry point contract in an on-chain environment, the user operation with the verifiable credential for the user;
validating, by the entry point contract, the user operation using a validation function in a smart contract wallet;
determining, by the entry point contract, that there is a paymaster to sponsor the transaction;
determining, by a paymaster contract for the paymaster, that the transaction should be sponsored based on the verifiable credential for the user;
executing, by the entry point contract, the transaction using an arbitrary execution function in the smart contract wallet; and
invoking, by the entry point contract, a post-operation that performs post-operation logic.

9. The method of claim 8, further comprising:
signing, by a signer service in the off-chain environment, the user operation.

10. The method of claim 9, further comprising:
creating, by the signer service, an on-chain verifiable presentation for the verifiable credential, wherein the verifiable credential is received from an identity digital wallet for the user in the off-chain environment.

11. The method of claim 8, wherein the user operation comprises a blockchain address for the user, a unique identifier, initialization code for setting up a new contact for the transaction, and a gas limit for execution and verification of the transaction.

12. The method of claim 8, further comprising:
bundling, by a bundler in the off-chain environment, the user operation with a plurality of user operations.

13. The method of claim 8, wherein the entry point contract further validates the user operation using an authorization module smart contract.

14. The method of claim 8, wherein the paymaster sponsors a gas fee for the transaction.

15. A non-transitory computer readable storage medium, including instructions stored thereon, which when read and executed by one or more computer processors, cause the one or more computer processors to perform steps comprising:
creating, using an application executed by a user electronic device in an off-chain environment, a user operation for a transaction based on an intention received from a user;
receiving, using a paymaster service in the off-chain environment, the user operation;
determining, using the paymaster service, that the transaction is eligible for sponsoring;
receiving, using the paymaster service, a verifiable presentation comprising a verifiable credential for the user from a user identity wallet, wherein the verifiable presentation is signed by a signer service;
passing, using the paymaster service, the user operation and the verifiable presentation to a merchant paymaster service;
verifying, using the merchant paymaster service and using an off-chain verification service, the user operation;
receiving, using an entry point contract in an on-chain environment, the user operation with the verifiable credential for the user;
validating, using the entry point contract, the user operation using a validation function in a smart contract wallet;
determining, using the entry point contract, that there is a paymaster to sponsor the transaction;
determining, using a paymaster contract for the paymaster, that the transaction should be sponsored based on the verifiable credential for the user;
executing, using the entry point contract, the transaction using an arbitrary execution function in the smart contract wallet; and
invoking, using the entry point contract, a post-operation that performs post-operation logic.

16. The non-transitory computer readable storage medium of claim 15, further including instructions stored thereon, which when read and executed by the one or more computer processors, cause the one or more computer processors to perform steps comprising:
signing the user operation.

17. The non-transitory computer readable storage medium of claim 16, further including instructions stored thereon, which when read and executed by the one or more computer processors, cause the one or more computer processors to perform steps comprising:
creating an on-chain verifiable presentation for the verifiable credential, wherein the verifiable credential is received from an identity digital wallet for the user in the off-chain environment.

18. The non-transitory computer readable storage medium of claim 15, wherein the user operation comprises a blockchain address for the user, a unique identifier, initialization code for setting up a new contact for the transaction, and a gas limit for execution and verification of the transaction.

19. The non-transitory computer readable storage medium of claim 15, further including instructions stored thereon, which when read and executed by the one or more computer processors, cause the one or more computer processors to perform steps comprising:
bundling the user operation with a plurality of user operations.

20. The non-transitory computer readable storage medium of claim 15, further including instructions stored thereon, which when read and executed by the one or more computer processors, cause the one or more computer processors to perform steps comprising:
validating the user operation using an authorization module smart contract.
